(19) United States
(12) Patent Application Publication
(10) Pub. No.: US 2014/0083829 A1
(43) Pub. Date: Mar. 27, 2014

(54) Actuator Assembly Having An External Plunger Sleeve

(71) Applicant: TRW AUTOMOTIVE U.S. LLC, Livonia, MI (US)

(72) Inventors: Tony Hart, Colne, Lancashire (GB); Boyuan Wu, Flint, MI (US); Bogdan Szalad, Dearborn Heights, MI (US); Derek Bennett, Romulus, MI (US)

(73) Assignee: TRW AUTOMOTIVE U.S. LLC, Livonia, MI (US)

(21) Appl. No.: 13/841,374

(22) Filed: Mar. 15, 2013

Related U.S. Application Data
(60) Provisional application No. 61/706,470, filed on Sep. 27, 2012.

(51) Int. Cl. H01H 3/02

(52) U.S. Cl. CPC H01H 3/02
USPC 200/338

(57) ABSTRACT

A plunger-style actuator assembly for use in a detent mechanism includes a guide post and an external plunger sleeve supported for sliding movement over the guide post. The external plunger sleeve rides along bearing surfaces that longitudinally extend between the guide post and the external plunger sleeve.

### CROSS-REFERENCE TO RELATED APPLICATIONS

This application claims the benefit of U.S. Provisional Application No. 61/706470, filed Sep. 27, 2012, the disclosure of which is incorporated herein by reference.

### BACKGROUND OF THE INVENTION

This invention relates in general to plunger-style actuator assemblies that can be used, for example, to bias an actuator lever assembly in various pivotal positions. In particular, this invention relates to a plunger-style actuator assembly having a guide post and an external plunger sleeve that is supported for sliding movement over the guide post.

A typical actuator lever assembly, such as in a multi-function switch lever assembly for example, includes a lever arm that is supported for pivotal movement on a base structure. To bias the lever arm in various positions, a plunger-style actuator assembly can be provided on the actuator lever assembly. A typical plunger-style actuator assembly includes a hollow guide post that extends from the lever arm and has an open distal end. An internal plunger member is supported for sliding movement within the hollow guide post and a distal end of the plunger member extends from the open end of the guide post. A spring member is provided between the guide post and the plunger member to bias the plunger member in an extended position relative to the guide post for contact with a cam surface. As the lever arm is pivoted, the plunger member rides along the cam surface, which is configured to bias the lever arm in the various positions.

In a typical actuator assembly of this type, the internal plunger member has an outer cross-sectional shape that corresponds with an inner cross-sectional shape of the guide post. To prevent the plunger member from binding within the guide post, the outer dimensions of the plunger member are smaller than the inner dimensions of the guide post so as to create a clearance between the mating components. However, such a design creates looseness in a radial direction between the mating components, which can be undesirable in certain applications. To reduce the radial looseness, the mating components typically incorporate complex cross-sectional shapes and key dimensions are manufactured with relatively tight tolerances. However, this can increase the manufacturing and assembly costs of the actuator assembly. Thus, it would be desirable to provide a plunger-style actuator assembly that reduces or eliminates radial looseness between the mating components and that is cost effective to manufacture and assemble.

### SUMMARY OF THE INVENTION

This invention relates to a plunger-style actuator assembly having a guide post and an external plunger sleeve that is supported for sliding movement over the guide post.

A plunger-style actuator assembly for use in a detent mechanism includes a guide post. The plunger-style actuator assembly includes an external plunger sleeve. The external plunger sleeve is supported for sliding movement over the guide post. The external plunger sleeve rides along bearing surfaces that longitudinally extend between the guide post and the external plunger sleeve.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an actuator lever assembly having a plunger-style actuator assembly, in accordance with this invention.

FIG. 2 is an enlarged cross-sectional side view of the actuator assembly shown in FIG. 1.

FIG. 3 is an enlarged perspective view of a guide post of the actuator assembly as shown in FIG. 2.

FIG. 4 is an enlarged end view of the guide post shown in FIG. 3.

FIG. 5 is an enlarged perspective view of an external plunger sleeve of the actuator assembly as shown in FIG. 2.

FIG. 6 is an enlarged end view of the external plunger sleeve as shown in FIG. 5.

FIG. 7 is an enlarged cross-sectional end view of the external plunger sleeve prior to being assembled on the guide post as shown in FIG. 2.

FIG. 8 is an enlarged cross-sectional end view of the external plunger sleeve assembled on the guide post as shown in FIG. 2.

### DETAILED DESCRIPTION OF THE PREFERRED EMBODIMENT

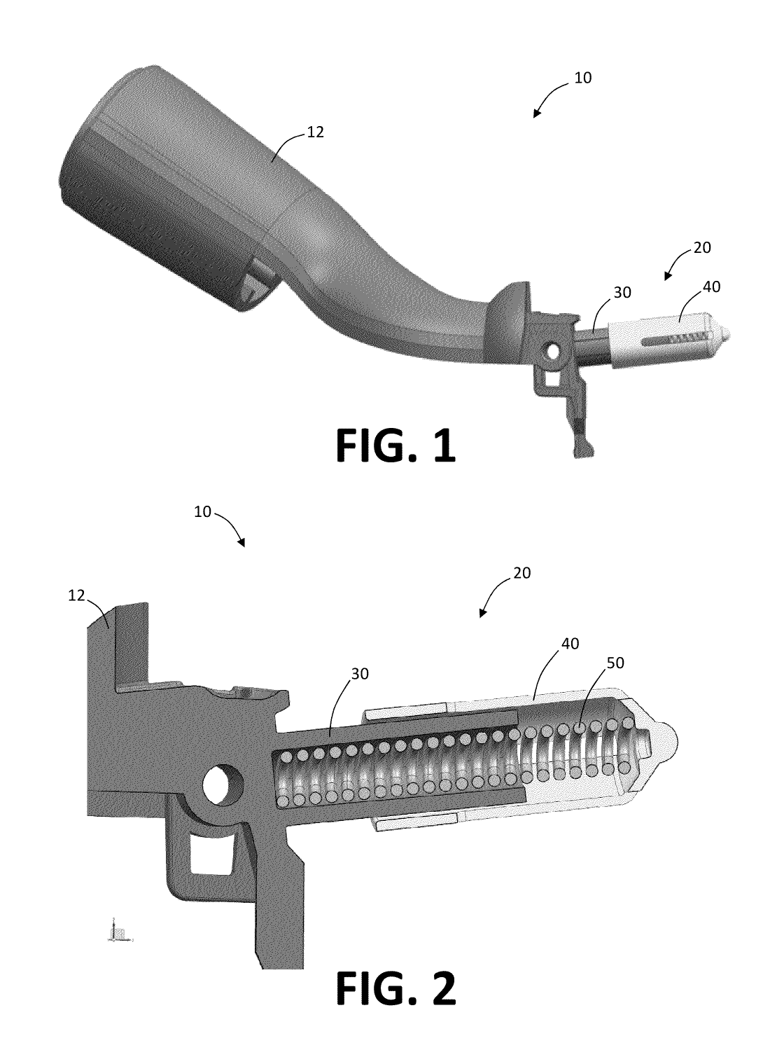

Referring now to the drawings, there is illustrated in FIG. 1 an actuator lever assembly, indicated generally at 10. The actuator lever assembly 10 includes a lever arm 12 that is supported on a base structure (not shown) for pivotal movement between various positions. For example, the actuator lever assembly 10 can be pivotally mounted on a steering column module (not shown) of a vehicle to selectively operate turn signals, headlight beams, wipers, etc. To facilitate movement between the various positions, the illustrated actuator lever assembly 10 includes a plunger-style actuator assembly, indicated generally at 20. The actuator assembly 20 functions within a detent mechanism to bias the lever arm 12 in a desired position. The actuator assembly 20 also provides a tactile feedback to the user when pivoting the lever arm 12 between the various positions. It should be appreciated, however, that the scope of this invention is not limited for use with the specific structure of the actuator lever assembly 10 or with pivotal lever arms in general. The illustrated actuator assembly 20 can be used in any desired environment and for any desired purpose.

Referring now to FIG. 2, the actuator assembly 20 will initially be described in general detail. The illustrated actuator assembly 20 includes a guide post 30. An external plunger sleeve 40 is supported over the guide post 30 for sliding movement in an axial direction between an extended position and a retracted position. A spring member 50 is provided between the guide post 30 and the external plunger sleeve 40 to bias the external plunger sleeve 40 in the extended position relative to the guide post 30.

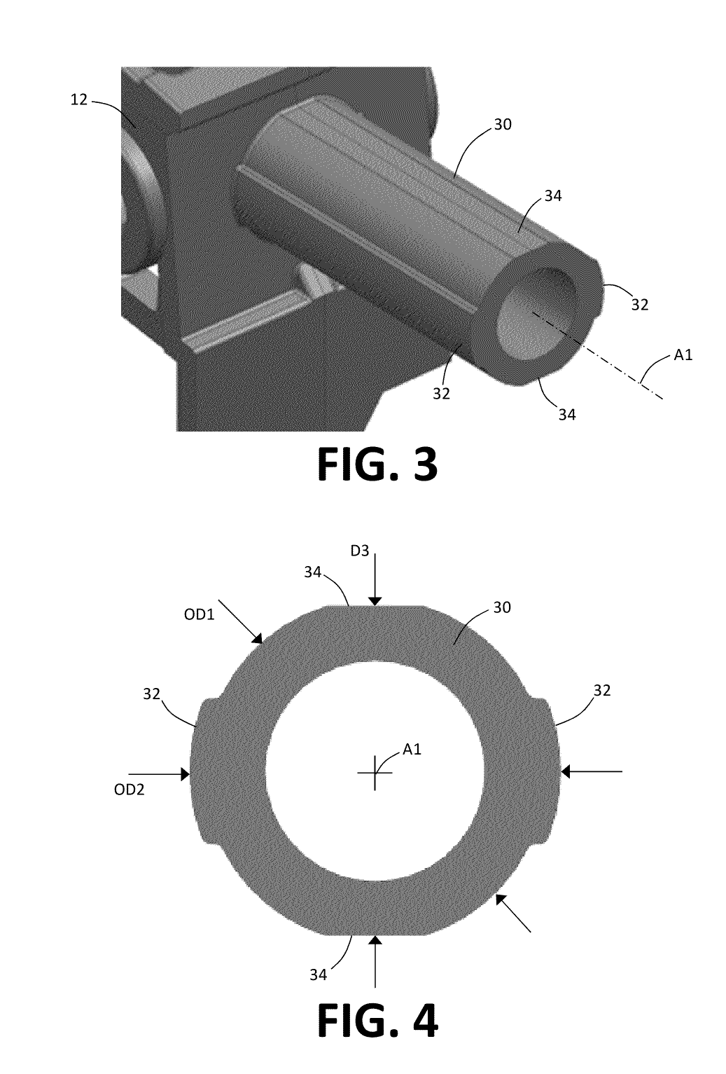

The individual components of the actuator assembly 20 will now be described in further detail. Referring to FIGS. 3 and 4, the illustrated guide post 30 is a generally cylindrical member that defines a longitudinal axis A1 and extends outwardly from a portion of the lever arm 12. The guide post 30 can have any desired axial length and preferably defines a constant cross-sectional shape along at least a portion of the axial length thereof, which will be explained below. The illustrated guide post 30 is integrally formed with the lever arm 12 or, alternatively, can be a separate component that is attached thereto. Further, the guide post 30 is preferably made from a rigid material such as, but not limited to, a glass fiber-reinforced polymer or the like to provide adequate support for the actuator assembly 20.

As shown in FIG. 4, the cross-sectional shape of the guide post 30 will now be described. The illustrated guide post 30 defines an outer cylindrical surface having a first outer diameter OD1. A pair of stepped surfaces 32 is provided along the outer cylindrical surface of the guide post 30. The illustrated stepped surfaces 32 longitudinally extend along at least a portion of the axial length of the guide post 30 and outwardly in a radial direction from the outer cylindrical surface. The stepped surfaces 32 also define cylindrical outer surfaces having a second outer diameter OD2 that is larger than the first outer diameter OD1. Further, the stepped surfaces 32 can be circumferentially spaced apart from one another an equal distance about the outer diameter OD1 of the guide post 30 (i.e., located on opposite sides of the guide post 30), although such is not required, and can have any desired circumferential widths.

The guide post 30 may also include a pair of flat surfaces 34 provided along the outer surface thereof, although such are not required. The illustrated flat surfaces 34 longitudinally extend along at least a portion of the axial length of the guide post 30. The flat surfaces 34 can be circumferentially spaced apart from one another an equal distance about the first outer diameter OD1 or the second outer diameter OD2 of the guide post 30 and an equal distance between the stepped surfaces 32, although neither are required. A distance D3 between the respective flat surfaces 34 is smaller than the first outer diameter OD1 of the outer cylindrical surface. Further, the flat surfaces 34 can have any desired width.

As best shown in FIG. 4, the guide post 30 generally has an elliptical cross-sectional shape. The elliptical cross-sectional shape includes a plurality of linear edges, formed by the stepped surfaces 32 and the flat surfaces 34, which longitudinally extend along at least a portion of the axial length of the guide post 30 and outwardly in a radial direction from the longitudinal axis A1. The linear edges need not define continuous edges, but may alternatively include interrupted portions along the axial length thereof. The purpose of the linear edges will be explained below. It should be appreciated that the cross-sectional shape of the guide post 30 is not limited to the illustrated embodiment, but may otherwise be any non-circular shape that defines a plurality of linear edges.

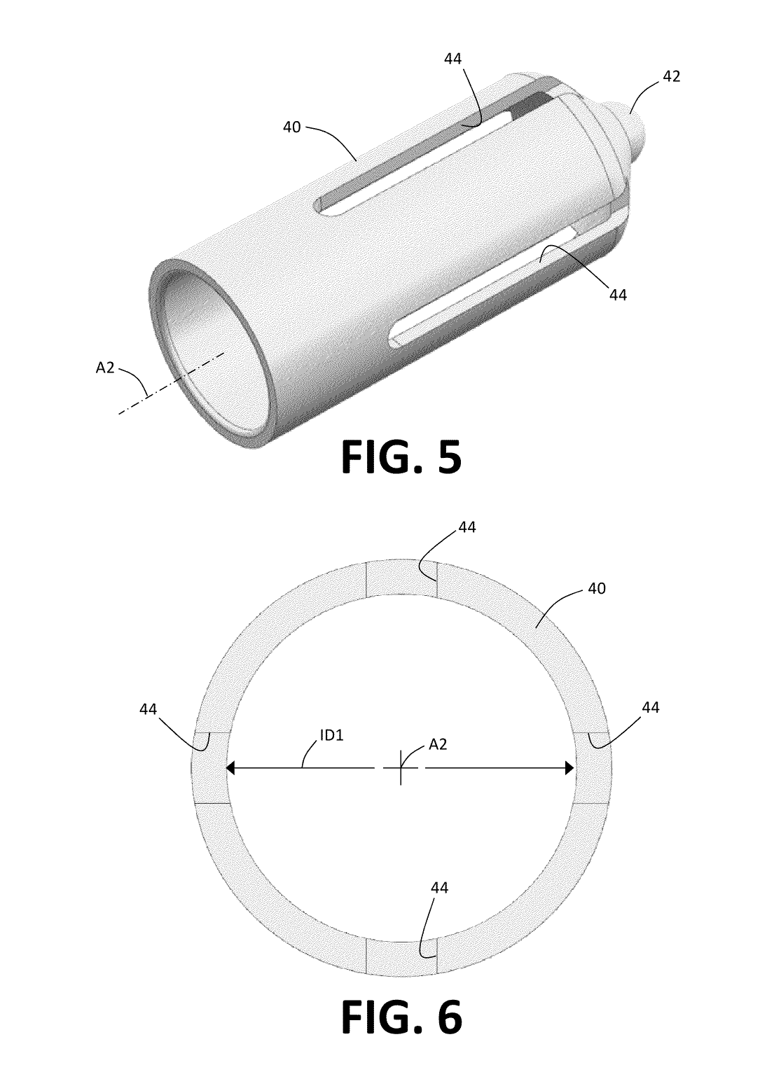

Referring now to FIGS. 5 and 6, the illustrated external plunger sleeve 40 is a cylindrical member having a longitudinal axis A2 with an open end and an opposite closed end. The closed end of the external plunger sleeve 40 defines a spherical protrusion 42 that extends outwardly in an axial direction. As shown in FIG. 6, the external plunger sleeve 40 has a circular inner diameter ID1. The external plunger sleeve 40 is preferably made from any generally resilient, yet flexible material that allows the cross-sectional shape thereof to elastically deform, the purpose of which will be explained below. In one non-limiting example, the external plunger sleeve 40 can be made from a nylon-based polymer or the like. Further, the external plunger sleeve 40 can have any desired axial length or radial dimensions.

As shown in FIGS. 5 and 6, the illustrated external plunger sleeve 40 also includes a plurality of slits 44 that extend through the cylindrical wall thereof, although such are not required. The slits 44 longitudinally extend along at least a portion of the axial length of the external plunger sleeve 40 and are circumferentially spaced apart from one another an equal distance about the diameter thereof, although such is not required. And although four slits 44 are illustrated in FIG. 6, the external plunger sleeve 40 may include any desired number or circumferential configuration of slits 44. Further, the slits 44 may have any desired axial length or circumferential width and can extend along any portion of the external plunger sleeve 40. The purpose of the slits 44 will be explained below.

Referring back to FIG. 2, the illustrated spring member 50 is provided between the guide post 30 and the external plunger sleeve 40. The spring member 50 can be a helical compression spring that is formed from a resilient material such as, for example, a spring metal or the like. In the illustrated embodiment, a first end of the spring member 50 is supported within the guide post 30 and a second end axially extends into the external plunger sleeve 40 for contact with the closed end thereof. As such, the spring member 50 biases the external plunger sleeve 40 in the extended position relative to the guide post 30. The spring member 50 can have any desired length, diameter, or spring stiffness. It should be appreciated, however, that the spring member 50 may be any other resilient component or may otherwise be configured in any manner to bias the external plunger sleeve 40 in the extended position. For example, the actuator assembly 20 may include a plurality of external support spring members if desired.

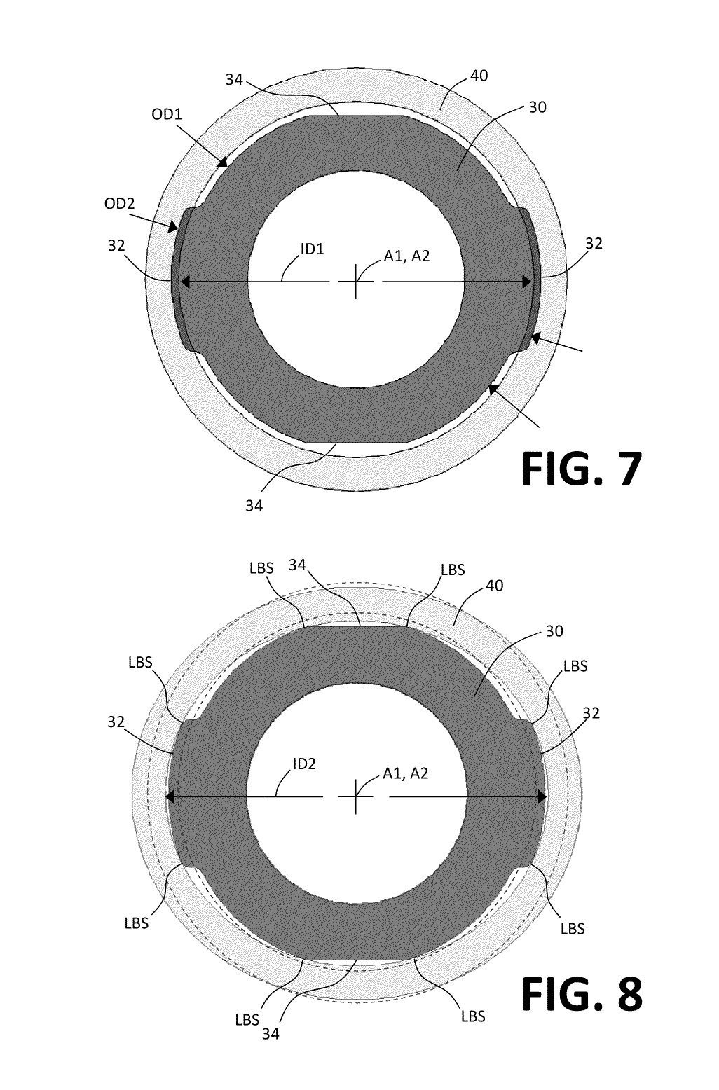

Referring now to FIGS. 7 and 8, the actuator assembly 20 will be described in further detail. As shown in FIG. 7, the external plunger sleeve 40 initially defines a circular cross-sectional shape having an inner diameter ID1. The inner diameter ID1 of the external plunger sleeve 40 is slightly larger than the first outer diameter OD1 of the guide post 30. However, the inner diameter ID1 is smaller than the second outer diameter OD2 of the stepped surfaces 32 and, therefore, creates an interference fit with the stepped surfaces 32 when the external plunger sleeve 40 is slid over the guide post 30.

As shown in FIG. 8, the circular cross-sectional shape of the external plunger sleeve 40 (illustrated as dotted lines) is configured to elastically deform, thereby conforming to the elliptical cross-sectional shape of the guide post 30. As a result, the inner surface of the external plunger sleeve 40 remains in contact with and slides along the linear edges that are formed by the stepped surfaces 32 and the flat surfaces 34 of the guide post 30, respectively. This creates linear bearing surfaces (i.e. linear contact paths) between the external plunger sleeve 40 and the guide post 30, which are identified by the reference characters LBS in FIG. 8. The linear bearing surfaces LBS longitudinally extend in the axial direction between the guide post 30 and the external plunger sleeve 40. As such, the linear bearing surfaces LBS create a line-to-line fit that eliminates radial looseness between the external plunger sleeve 40 and the guide post 30. The linear bearing surfaces LBS need not be continuous surfaces, but may included interrupted portions along the axial lengths thereof. The amount of friction (or lack thereof) along the linear bearing surfaces LBS can be achieved through material selection of the components, geometry of the linear bearing surfaces LBS, the cross-sectional configuration of the components, and/or the use of lubrication, although such is not required.

The illustrated actuator assembly 20 provides a number of advantages. The external sleeve design allows the external plunger sleeve 40 to have an interference fit with the guide post 30, by design, which helps to eliminate or reduce the radial looseness (i.e., free play) between the external plunger sleeve 40 and the guide post 30. In turn, the decrease in radial looseness helps to increases the accuracy in the actuator assembly 20, which can be advantages in many applications. The external sleeve design also enables the external plunger sleeve 40 to elastically deform when slid over the guide post 30 to form the linear bearing surfaces LBS, which further helps to eliminate or reduce the radial looseness between the external plunger sleeve 40 and the guide post 30 and results in a much simpler component design. A simpler component design helps to reduce the number of dimensions that need to be manufactured with relatively tight tolerances, which can reduce the manufacturing and assembly costs of the actuator assembly 20. Further, the optional slits 44 allow the external plunger sleeve 40 to elastically deform more easily and consistently when slid over the guide post 30. These advantages also result in more robust tooling designs, which enable the molding of statically capable components for use in high volume productions environments. It should also be appreciated that the illustrated actuator assembly 20 may provide additional advantages which are not disclosed herein.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A plunger-style actuator assembly for use in a detent mechanism comprising:
a guide post; and
an external plunger sleeve supported for sliding movement over the guide post, wherein the external plunger sleeve rides along bearing surfaces that longitudinally extend between the guide post and the external plunger sleeve.

2. The plunger-style actuator assembly of claim 1, wherein a cross-sectional shape of the external plunger sleeve is elastically deformable over the guide post to provide an interference fit along the bearing surfaces.
